(19) United States
(12) Patent Application Publication
(10) Pub. No.: US 2014/0223577 A1
(43) Pub. Date: Aug. 7, 2014

(54) METHOD AND SYSTEM FOR AUTHENTICATING OPTICAL DISC APPARATUS

(71) Applicant: Toshiba Samsung Storage Technology Korea Corporation, Suwon-si (KR)

(72) Inventor: Jae-young LEE, Anyang-si (KR)

(73) Assignee: Toshiba Samsung Storage Technology Korea Corporation, Suwon-si (KR)

(21) Appl. No.: 14/173,210

(22) Filed: Feb. 5, 2014

(30) Foreign Application Priority Data
Feb. 5, 2013 (KR) 10-2013-0013080

(51) Int. Cl. G06F 21/62

(52) U.S. Cl. CPC G06F 21/62
USPC 726/27

(57) ABSTRACT

Provided are a method and system for authenticating an optical disc apparatus. The method includes capturing an image code attached to the optical disc apparatus, acquiring authentication information on the optical disc apparatus by using the image code, comparing information received from the optical disc apparatus with the authentication information on the optical disc apparatus, and authenticating the optical disc apparatus according to a comparison result.

CROSS-REFERENCE TO RELATED PATENT APPLICATION

This application claims the benefit under 35 U.S.C. §119(a) of Korean Patent Application No. 10-2013-0013080, filed on Feb. 5, 2013, in the Korean Intellectual Property Office, the entire disclosure of which is incorporated herein by reference for all purposes.

### BACKGROUND

1. Field

The following description relates to a method and system for authenticating an optical disc apparatus, and more particularly, to a method and system for authenticating an optical disc apparatus by using an image code.

2. Description of Related Art

An optical disc drive (ODD) is a conventional apparatus for storing and reproducing content in and from an optical disc. Examples of optical discs include compact discs (CDs) and digital versatile discs (DVDs). In addition, blue-ray discs (BDs) are gaining popularity as the next-generation of optical discs. Most DVD apparatuses are compatible with low capacity CDs, and optical media devices compatible with CDs, DVDs, and BDs have been proposed.

Control devices for controlling an optical media device include general purpose devices (e.g., personal computers (PCs)), image reproduction apparatuses (e.g., smart TVs), and personal handheld terminals (e.g., smart phones or tablet PCs). Such control devices may be used in a wide variety of applications as audio/video hosts that can play back different types of content. These control devices may also include a built-in function to display various types of content stored in a peripheral device when connected to the peripheral device.

In a wireless network environment, an optical media device may communicate with a plurality of control devices. However, for purposes of security it may be desirable for a specific control device to be allocated for controlling the optical media device. That is, it may be desirable to limit the amount of control devices that are authenticated to control an optical media device. Furthermore, it may be beneficial to allow only a particular control device to access or use the optical media device.

### SUMMARY

In an aspect, there is provided a method for authenticating an optical disc apparatus in a host device, the method including capturing a picture of an image code attached to the optical disc apparatus, acquiring authentication information on the optical disc apparatus from a server based on the picture of the image code, and comparing information received from the optical disc apparatus with the acquired authentication information and authenticating the optical disc apparatus based on a result of the comparison.

The authentication information may be acquired based on a Uniform Resource Locator (URL) that is included in the image code.

The acquiring of the authentication information on the optical disc apparatus may include accessing a server that has the URL included in the image code and receiving the authentication information from the server.

The authentication information on the optical disc apparatus may be pre-registered in the server and may be mapped to identification information of the optical disc apparatus.

The method may further comprise displaying a screen requesting user authentication upon accessing the server, wherein the authentication information is received from the server in response to the user authentication being completed.

The authenticating of the optical disc apparatus may comprise transmitting a temporary key used to encrypt the authentication information to the optical disc apparatus, receiving information encrypted based on the temporary key from the optical disc apparatus, and decrypting the encrypted information and determining whether the authentication information is included in the encrypted information.

The method may further comprise controlling the optical disc apparatus in response to the authentication information being the same as information included in the encrypted information.

The authenticating of the optical disc apparatus may be performed in a short-range wireless communication manner.

The image code may include at least one of a bar code, a Quick Response (QR) code, a Data Matrix code, a PDF417 code, a Maxi Code, a Color code, a Gray Code, and a three-dimensional (3D) bar code.

The host device may comprise a handheld terminal.

In an aspect, there is provided a host device for authenticating an optical disc apparatus, the host device including an interface device configured to communicate with the optical disc apparatus, an imaging device configured to image an image code attached to the optical disc apparatus, and a controller configured to acquire authentication information on the optical disc apparatus based on the image code and compare information received from the optical disc apparatus with the acquired authentication information to authenticate the optical disc apparatus.

The controller may be configured to acquire the authentication information based on a Uniform Resource Locator (URL) that is included in the image code.

The controller may access a server having the URL included in the image code and receive the authentication information from the server through the interface device.

The authentication information on the optical disc apparatus may be pre-registered in the server and may be mapped to identification information of the optical disc apparatus.

The host device may further comprise a display device configured to display a screen requesting user authentication when the controller accesses the server, wherein the controller receives the authentication information from the server in response to the user authentication being completed.

The controller may be configured to transmit a temporary key to encrypt the authentication information to the optical disc apparatus through the interface device, receive information encrypted based on the temporary key from the optical disc apparatus, and decrypt the encrypted information to determine whether the authentication information is included in the encrypted information.

The controller may be configured to control the optical disc apparatus in response to the authentication information being the same as information included in the encrypted information.

The image code may include at least one of a bar code, a Quick Response (QR) code, a Data Matrix code, a PDF417 code, a Maxi Code, a Color code, a Gray Code, and a three-dimensional (3D) bar code.

In an aspect, there is provided a system for authenticating an optical disc apparatus, the system including the optical disc apparatus having an image code attached to an outer surface thereof, and a host device that authenticates the optical disc apparatus by imaging the image code.

The system may further include a server to store identification information about the optical disc apparatus and authentication information on optical disc apparatus mapped thereto, wherein the host device accesses the server based on a Uniform Resource Locator (URL) of the server included in the image code and receives the authentication information on the optical disc apparatus from the server.

In an aspect, there is provided an optical disc apparatus including a storage unit configured to store authentication information of the optical disc apparatus, and a controller to read the stored authentication information upon receipt of an authentication request message from a host device, transmit an encrypted authentication response message to the host device, and register the host device as an authenticated host device upon receipt of an authentication completion message from the host device, the authentication request message being generated by the host device by imaging image code disposed on an outer surface of the optical disc apparatus.

The host device may transmit a control message to the optical disc apparatus to enable the host device to control the optical disc apparatus in response to authenticating the host device.

### BRIEF DESCRIPTION OF THE DRAWINGS

FIG. 1 is a diagram illustrating an example of a system for authenticating an optical disc apparatus;

FIG. 2 is a diagram illustrating an example of an optical disc apparatus in the system of FIG. 1;

FIG. 3 is a diagram illustrating an example of a host device in the system of FIG. 1,

FIG. 4 is a diagram illustrating an example of a server in the system of FIG. 1;

FIG. 5 is a flowchart illustrating a method of authenticating an optical disc apparatus in a host device by using image code; and

FIG. 6 illustrates an example of an optical disc apparatus having an image code attached thereto.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example. However, the sequence of and/or operations is not limited to that set forth herein and may be changed as is known in the art, with the exception of steps and/or operations necessarily occurring in a certain order. Also, descriptions of well-known functions and constructions may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

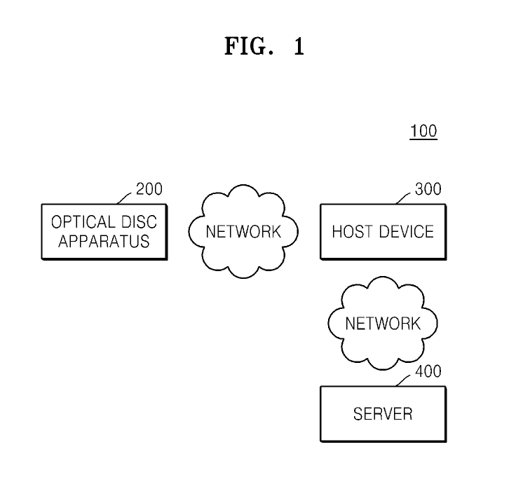

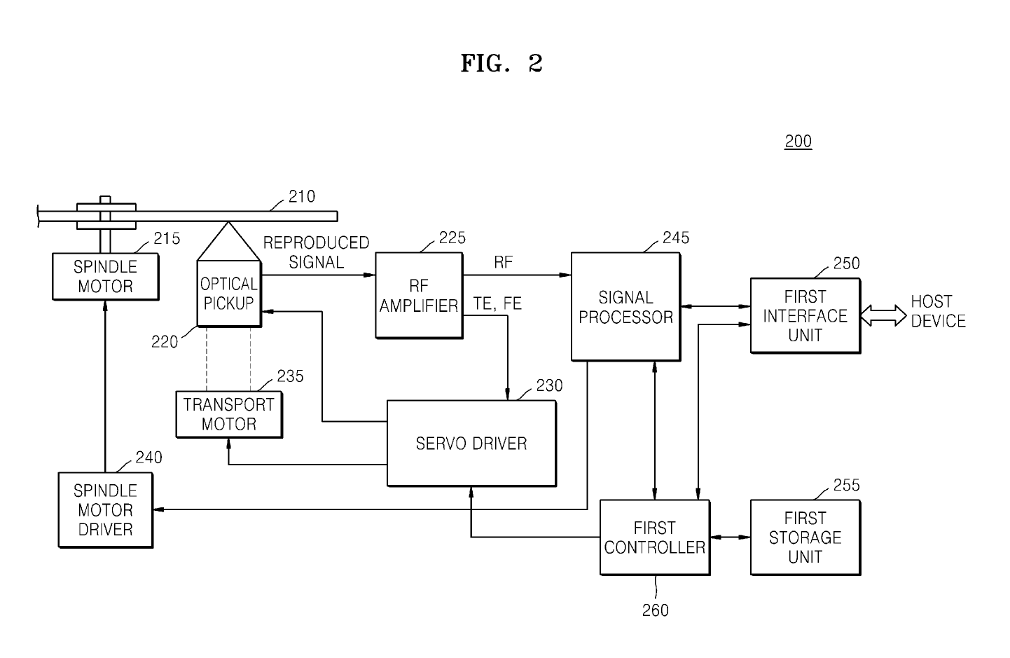

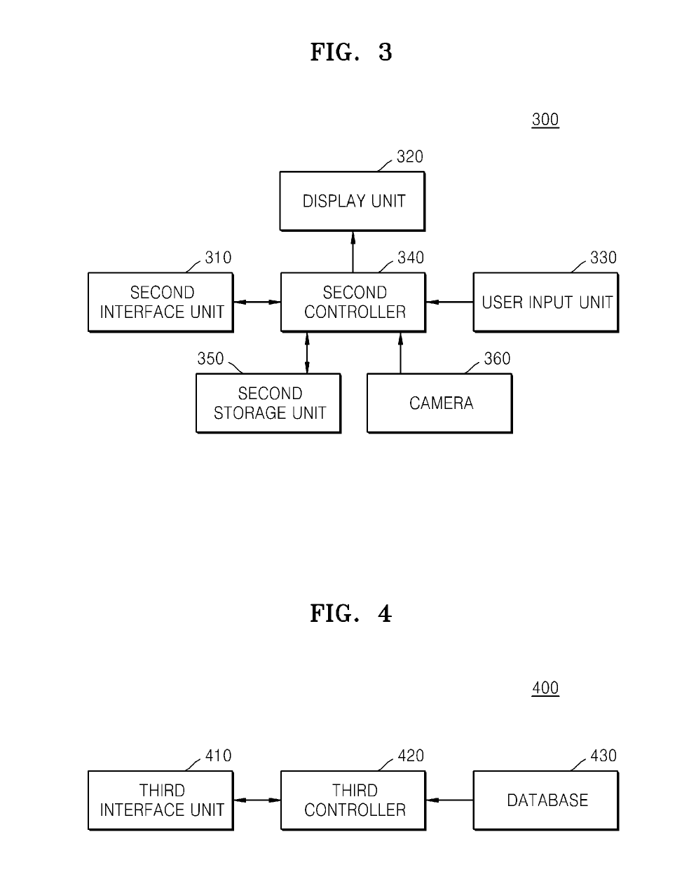

FIG. 1 illustrates an example of a system 100 for authenticating an optical disc apparatus 200. FIG. 2 illustrates an example of the optical disc apparatus 200 in the system 100 of FIG. 1. FIG. 3 illustrates an example of a host device 300 in the system 100 of FIG. 1. FIG. 4 illustrates an example of a server 400 in the system 100 of FIG. 1.

Referring to FIGS. 1 through 4, the system 100 includes the optical disc apparatus 200 to record or reproduce content on or from an optical disc, the host device 300 to control the optical disc apparatus 200, and the server 400 to store authentication information on the optical disc apparatus 200.

Here, the optical disc apparatus 200 may write content to and/or read content from an optical disc 210 and may also connect to the host device 300 via a network to receive a control message from and transmit/receive data to/from the host device 300. For example, the optical disc apparatus 200 may be a Compact Disc Read-Only Memory (CD-ROM) drive, a CD-Rewritable (CD-RW) drive, or CD-Random Access Memory (CD-RAM) drive, and the like. As another example, the optical disc apparatus 200 may be a Digital Versatile Disc Read-Only Memory (DVD-ROM) drive, a DVD-RW drive, a DVD-RAM drive, a Blu-ray (BR) based drive, and the like.

Referring to FIG. 2, the optical disc apparatus 200 includes an optical pickup 220 to reproduce information recorded on the optical disc 210. The optical pickup 220 may optically pick up information recorded on a surface of the optical disc 210 while the optical disc 210 is rotated by a spindle motor 215. The optical pickup 220 may convert the information into a radio frequency (RF) signal, and send the RF signal to an RF amplifier 225. In this example, the optical pickup 220 is supported by a transport motor 235 and is radially movable with respect to the optical disc 210.

The RF amplifier 225 may amplify the RF signal received from the optical pickup 220, remove noise and distortion from the amplified signal, and send the resulting signal to a signal processor 245. For example, the RF amplifier 225 may send focus servo and tracking servo signals, such as a focus error signal FE and a tracking error signal TE, to the servo driver 230. The servo driver 230 may output a focus servo control signal and a tracking servo control signal to a trasnsport motor 235 based on the focus error signal FE and the tracking error signal TE. The servo driver 230 may supply operating power to be used for tracking servo and focus servo operations to the optical pickup 220 and the transport motor 235 in response to various control signals output by a first controller.

The signal processor 245 may decode the RF signal transmitted by the RF amplifier 225, perform error correction on the decoded data, and transmits the resulting data to a first interface unit 250. The signal processor 245 may also control a spindle motor driver 240 to drive the spindle motor 215 by sending a control signal to the spindle motor driver 240 to drive the spindle motor 215. In this example, the first interface unit 250 may deliver various control signals transmitted between the host device 300, such as a handheld terminal, and the optical disc 200 and output data received from the signal processor 245 to the host device 300.

For example, a first storage unit 255 may include read-only memory (ROM) to store control programs that are used to perform operations of the optical disc apparatus 200 and random-access memory (RAM) to temporarily store various data that is used to perform the operations of the optical disc apparatus 200 or various data generated during operation thereof. In this example, authentication information on the optical disc apparatus 200 may be stored in the ROM.

A first controller 260 may control overall operations of the optical disc apparatus 200. For example, the first controller 260 may read control programs from the first storage unit 255 to operate the optical disc apparatus 200 and control components of the optical disc apparatus 200. As an example, upon receipt of a request for authentication information from the host device 300, the first controller 260 may read the authentication information on the optical disc apparatus 200 from the first storage unit 255 and transmit the authentication information to the host device 300. The first controller 260 may also control the optical disc apparatus 200 based on a control message received from an authenticated host device 300.

Referring to FIG. 3, the host device 300 may transmit a control message to, and transmits/receives data to/from, the optical disc apparatus 200 via a wireless or wired communication manner. For example, the host device 300 may be a computer or a handheld terminal. For convenience of explanation, the host device 300 is assumed to be a handheld terminal. Examples of a handheld terminal include, but are not limited to, a mobile phone, a smart phone, a notebook computer, a digital broadcasting terminal, a Personal Digital Assistant (PDA), a Portable Multimedia Player (PMP), a navigation system, a remote control terminal, and the like.

In this example, the host device 300 includes a second interface unit 310 to perform wireless communication with the optical disc apparatus 200, a display unit 320 to display playback status of the optical disc apparatus 200 or the results of user commands, a user input unit 330 to allow a user to enter user commands to set a recording or to reproduce the optical disc apparatus 200, and a second controller 340 to generate a control message in response to a user command.

The second interface unit 310 may include various communication modules, for example, a mobile communication module, a wireless Internet module, and a short-range communication module. The mobile communication module may be used to transmit and receive a wireless signal to and from at least one of a base station, an external terminal, and a server on a mobile communications network. The wireless Internet module may provide Internet access, and may be built into, or be separate from, the host device 300. The short-range communication module may provide short range communication and may include a wireless local area network (LAN) card.

The wireless LAN card may use at least one of the wireless communication methods defined by the 802.11 wireless networking standards proposed by Institute of Electrical and Electronics Engineers (IEEE) for wireless LAN technologies including wireless LANs and some infrared (IR) communications. For example, the wireless LAN card may use an IEEE 802.15 standard for wireless personal area networks (PANs) which includes Bluetooth, Ultra-wideband (UWB), and Zigbee networks. The wireless LAN card may use an IEEE 802.16 standard for wireless Metropolitan Area Networks (MANs) which includes Fixed Wireless Access (FWA) and Broadband Wireless Access (BWA) networks, and the IEEE 802.20 Mobile Broadband Wireless Access (MBWA) standard for mobile Internet networks which includes wireless broadband (Wibro) and worldwide interoperability for microwave access (WIMAX) networks.

The second interface unit 310 may communicate with the optical disc apparatus 200 using a short-range communication module. The second interface unit 310 may also communicate with the server 400 using at least one of a mobile communication module, a wireless Internet module, and a short-range communication module. An example of a method that the second interface unit 310 may use to communicate with the optical disc apparatus 200 or server 400 is not described hereinafter for purposes of convenience.

The user input unit 330 may generate key input data that is entered to control the operation of the host device 300. For example, the user input unit 330 may include a key pad and a touch pad. Further, when the touch pad is disposed on the display unit 320 to form a cross-layer structure, a touch screen may be formed.

The display unit 320 may display information that is processed by the host device 300. For example, the display unit 320 may display an image related to an authentication procedure of the optical apparatus 200, a playback list of the optical display apparatus 200, and the like.

In an example in which the display unit 320 and the touch pad form a cross-layer structure to construct a touch screen, as described above, the display unit 320 may be used as an input device as well as an output device. When the display unit 320 is a touch screen, the display unit 320 may include a touch screen panel and a touch screen panel controller. For example, the touch screen panel may be a transparent panel attached to an outer surface of the display unit 320, and may be connected to an internal bus of the host device 300. The touch screen panel may detect a position where a touch input occurs and, upon receipt of the touch input, send signals corresponding to the touch input to the touch screen panel controller. The touch screen channel controller may then process the received signals and transmit data corresponding to the signals to the second controller 340 so that the second controller 340 may recognize the presence of a touch input and a position of the touch input on a touch screen.

For example, the display unit 320 may include at least one of a liquid crystal display (LCD), a thin film transistor-liquid crystal display (TFT-LCD), an organic light-emitting diode (OLED), a flexible display, a transparent display, and a three-dimensional (3D) display, or the like.

The host device 300 may further include a second storage unit 350 to store programs used by the second controller 340 in order to process data or control various components, and to temporarily store data input or output.

For example, the second storage unit 350 may include at least one type of storage media including a flash memory type, a hard disk type, such as the optical disc 210, a multimedia card micro type, a card type memory (e.g., SD or XD memory), RAM, and ROM, or the like.

The host device 300 may further include a camera 360 to process image frames, such as still or moving images, obtained by an image sensor. The processed image frames may be displayed on the display unit 320.

Referring to FIG. 4, the server 400 may include a third interface unit 410 to communicate with the host device 300, a third controller 420 to generate various messages to communicate with the host device 300, and a database 430 in which authentication information on an optical disc apparatus is registered. It should be appreciated that the third interface unit 410 may have the same or similar function as the second interface unit 310 in the host device 300.

A list of host devices may be registered in the database 430. The host devices may be respectively mapped to optical disc apparatuses that the respective host devices can control. Furthermore, identification information about each optical disc apparatus may be mapped to its authentication information. Thus, upon receipt of a request for authentication information about an optical disc apparatus from a host device, the third controller 420 may determine whether the host device is a registered host device and, if the host device is a registered one, read authentication information mapped to identification information about the optical disc apparatus from the database 430, and send the authentication information to the corresponding host device.

According to various aspects, the optical disc apparatus 200 may have an image code attached thereto, for example, to an outer surface thereof. Examples of the image code may include, but are not limited to, a bar code, a Quick Response (QR) code, a Data Matrix code, PDF417, a Maxi Code, a Color code, a Gray Code, and a 3D bar code. Identification information about the optical disc apparatus and Uniform Resource Locator (URL) of the server 400 may be stored in the image code.

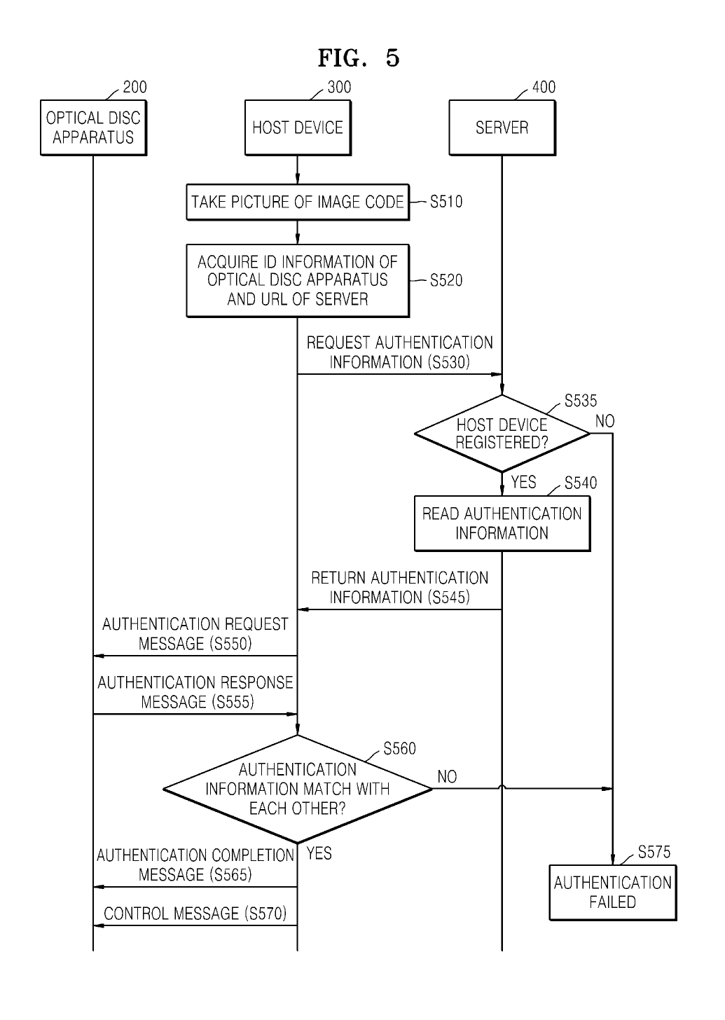

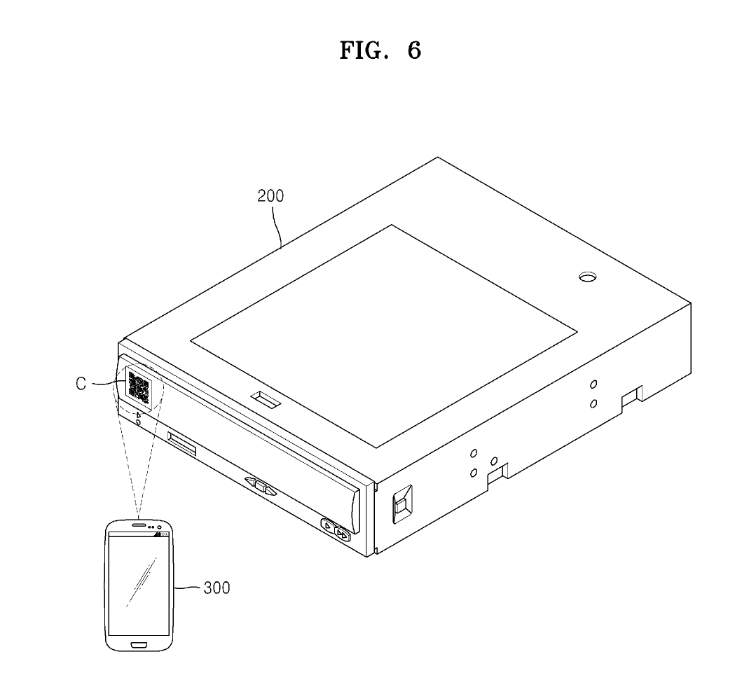

FIG. 5 illustrates an example of a method of authenticating an optical disc apparatus 200 in the host device 300 using an image code C. FIG. 6 illustrates an example of the optical disc apparatus 200 having the image code C attached thereto.

Referring to FIGS. 3 through 6, the host device 300 takes a picture of the image code C attached to the optical disc apparatus 200 (S510). As shown in FIG. 6, the image code C may be attached to an outer surface of the optical disc apparatus 200. For example, the image code C may be attached at a position where a user can see it easily and quickly.

For example, when the user desires to authenticate his/her handheld terminal as a control device for the optical disc apparatus 200, the user may enter a command to execute a program for recognizing image code of the handheld terminal. Here, the second controller 340 of the host device 300, that is, the handheld terminal, may load and execute the program stored in the second storage unit 350 or an external device. When the user directs the camera 360 towards the image code C, the second controller 340 may control the display unit 320 to display a preview image that is taken by the camera 360 and contains the image code C. Upon recognition of the image code C, the second controller 340 may control the display unit 320 to display a recognition notification. For example, the display unit 320 may display the message The process for authenticating the optical disc apparatus 200 has started by using an image code' upon recognition of the image code C.

After taking a picture of the image code, the second controller 240 acquires identification information about the optical disc apparatus 200 and a URL of the server 400 from the recognized image code (S520). For example, the identification information about the optical disc apparatus 200 may be at least one of a model name, a model number, a manufacture number, a serial number, a combination thereof, and the like.

According to various aspects, the second controller 340 may request authentication information on the optical disc apparatus 200 from the server 400 having the URL (S530). For example, the second controller 340 may run a web browser, and the host device 300 may access the server 400 having the acquired URL via wireless Internet communication, mobile communication, or wireless short-range communication. Here, the second controller 340 may send a request to the server 400 for the authentication information on the optical disc apparatus 200. Along with the request, the second controller 340 may send the acquired identification information about the optical disc apparatus 200 to the server 400.

The server 400 determines whether the host device 300 requesting the authentication information is a registered device (S535). For example, the third controller 420 of the server 400 may check if the host device requesting the authentication information is in a list of host devices that are registered in the database 430. The list of the host devices may be represented by identification information about the host devices. The identification information about each host device may be represented by at least one of an Internet Protocol (IP) and a Media Access Control (MAC) address, a combination thereof, and the like.

According to various aspects, if the host device 300 is registered (S535-Y), the server 400 reads authentication information mapped to the identification information about the optical disc apparatus 200 from the database 430 (S540) and transmits the authentication information to the host device 300 (S545). In this way, the host device 300 may acquire the authentication information on the optical disc apparatus 200. On the other hand, if the host device 300 is not registered (S535-N), the server 400 may send the result to the host device 300. Here, the second controller 340 may generate a notification indicating that authentication failed and control the display unit 320 to display the notification.

According to various aspects, a user authentication may be additionally performed to provide a more stable authentication process. For example, when the host device 300 gains access to the server 400, the display unit 320 of the host device 300 may display a web page requiring user authentication. Here, only when user authentication information, such as user ID or password, is entered into the web page, the server 400 may send authentication information to the host device 300.

The second controller 340 may generate a temporary key corresponding to authentication information and an authentication request message containing the temporary key. For example, the temporary key may be a binary or hexadecimal number. The second controller 340 sends the authentication request message to the optical disc apparatus 200 (S550). Upon receipt of the authentication request message, the first controller 260 of the optical disc apparatus 200 may read authentication information stored in the first storage unit 255. Further, the first controller 260 may also encrypt the read authentication information and the temporary key received from the host device 300 by using an encryption algorithm. For example, the encryption algorithm may be Advanced Encryption Standard (AES) logic.

The optical disc apparatus 200 sends an authentication response message containing the encrypted information to the host device (S555). Here, the second controller 340 of the host device 300 that has received the authentication response message may decrypt the encrypted information therein and determine whether the authentication information contained in the encrypted information matches the authentication information received from the server 400 (S560) by comparing the authentication information contained in the encrypted information with the authentication information received from the server 400.

According to various aspects, if the authentication information contained in the encrypted information matches the authentication information received from the server 400 (S560-Y), the host device 300 generates an authentication completion message and transmits the authentication completion message to the optical disc apparatus 200 (S565). Upon receipt of the authentication completion message from the host device 300, the optical disc apparatus 200 may register the host device 300 as an authenticated host device. By implementing the above method, the optical disc apparatus 200 may prevent access to unauthenticated host devices.

According to various aspects, the host device 300 transmits a control message to the optical disc apparatus 200, in response to completing the authentication, so that the optical disc apparatus 200 may be controlled by the host device 300. For example, the host device 300 may control the optical disc apparatus 200 to record or reproduce content (S570).

Alternatively, if the authentication information contained in the encrypted information does not match the authentication information received from the server 400 (S560-N), the host device 300 determines that the authentication of the optical disc apparatus 200 failed (S575). Here, the second controller 340 may generate a notification indicating that the authentication using the image code C failed and control the display unit 320 to display the notification.

According to various aspects, authentication of the optical disc apparatus 200 may be performed by capturing an image code of the optical disc apparatus using the host device 300, thereby minimizing user intervention and maximizing user convenience.

According to various aspects, the above method can be recorded as programs executable on a computer and implemented through general purpose digital computers which can run the programs by using a computer-readable recording medium. Data structures described in the above method can also be recorded on a non-transitory computer-readable medium in a variety of ways. Examples of the non-transitory computer-readable medium include recording media, such as magnetic storage media (e.g., ROM, RAM, USB, floppy disks, hard disks, etc.), optical recording media (e.g., CD-ROMs, or DVDs), and PC interfaces (e. g., PCI, PCI-express, or Wifi).

According to various aspects, an optical disc apparatus and a host device that desires to control the optical disc apparatus need to perform an authentication process by using an image code, thereby allowing access by only host devices that are able to control the optical disc apparatus.

Furthermore, because an authentication process may be performed using a temporary key, more stable authentication may be achieved. Authentication may also be performed by capturing the image code, thereby improving user convenience.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra-mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for authenticating an optical disc apparatus in a host device, the method comprising:
capturing a picture of an image code attached to the optical disc apparatus;
acquiring authentication information on the optical disc apparatus from a server based on the picture of the image code; and
comparing information received from the optical disc apparatus with the acquired authentication information and authenticating the optical disc apparatus based on a result of the comparison.

2. The method of claim 1, wherein the authentication information is acquired based on a Uniform Resource Locator (URL) that is included in the image code.

3. The method of claim 2, wherein the acquiring of the authentication information on the optical disc apparatus comprises accessing a server that has the URL included in the image code and receiving the authentication information from the server.

4. The method of claim 3, wherein the authentication information on the optical disc apparatus is pre-registered in the server and is mapped to identification information of the optical disc apparatus.

5. The method of claim 3, further comprising:
displaying a screen requesting user authentication upon accessing the server,
wherein the authentication information is received from the server in response to the user authentication being completed.

6. The method of claim 1, wherein the authenticating of the optical disc apparatus comprises:
transmitting a temporary key used to encrypt the authentication information to the optical disc apparatus;
receiving information encrypted based on the temporary key from the optical disc apparatus; and
decrypting the encrypted information and determining whether the authentication information is included in the encrypted information.

7. The method of claim 6, further comprising:
controlling the optical disc apparatus in response to the authentication information being the same as information included in the encrypted information.

8. The method of claim 1, wherein the authenticating of the optical disc apparatus is performed in a short-range wireless communication manner.

9. The method of claim 1, wherein the image code includes at least one of a bar code, a Quick Response (QR) code, a Data Matrix code, a PDF417 code, a Maxi Code, a Color code, a Gray Code, and a three-dimensional (3D) bar code.

10. The method of claim 1, wherein the host device comprises a handheld terminal.

11. A host device for authenticating an optical disc apparatus, the host device comprising:
an interface configured to communicate with the optical disc apparatus;
an imaging device configured to image an image code attached to the optical disc apparatus; and
a controller configured to acquire authentication information on the optical disc apparatus based on the image code and compare information received from the optical disc apparatus with the acquired authentication information to authenticate the optical disc apparatus.

12. The host device of claim 11, wherein the controller is configured to acquire the authentication information based on a Uniform Resource Locator (URL) that is included in the image code.

13. The host device of claim 12, wherein the controller accesses a server having the URL included in the image code and receives the authentication information from the server through the interface device.

14. The host device of claim 13, wherein the authentication information on the optical disc apparatus is pre-registered in the server and is mapped to identification information of the optical disc apparatus.

15. The host device of claim 13, further comprising:
a display device configured to display a screen requesting user authentication when the controller accesses the server,
wherein the controller receives the authentication information from the server in response to the user authentication being completed.

16. The host device of claim 11, wherein the controller is configured to transmit a temporary key to encrypt the authentication information to the optical disc apparatus through the interface device, receive information encrypted based on the temporary key from the optical disc apparatus, and decrypt the encrypted information to determine whether the authentication information is included in the encrypted information.

17. A system for authenticating an optical disc apparatus, the system comprising:
the optical disc apparatus having an image code attached to an outer surface thereof; and
a host device that authenticates the optical disc apparatus by capturing an image of the image code.

18. The system of claim 17, further comprising:
a server to store identification information about the optical disc apparatus and authentication information on optical disc apparatus mapped thereto,
wherein the host device accesses the server based on a Uniform Resource Locator (URL) of the server included in the image code and receives the authentication information on the optical disc apparatus from the server.

19. The system of claim 17, the optical disc apparatus comprising:
a storage device configured to store authentication information of the optical disc apparatus; and
a controller to read the stored authentication information upon receipt of an authentication request message from a host device, transmit an encrypted authentication response message to the host device, and register the host device as an authenticated host device upon receipt of an authentication completion message from the host device, the authentication request message being generated by the host device by imaging image code disposed on an outer surface of the optical disc apparatus.

20. The system of claim 19, wherein, in response to authenticating the host device, the host device transmits a control message to the optical disc apparatus to enable the host device to control the optical disc apparatus.
